(19) United States
(12) Patent Application Publication
(10) Pub. No.: US 2017/0305433 A1
(43) Pub. Date: Oct. 26, 2017

(54) DETERMINATION METHOD, INFORMATION PROCESSING DEVICE, AND COMPUTER-READABLE RECORDING MEDIUM

(71) Applicants: FUJITSU LIMITED, Kawasaki-shi (JP); NATIONAL UNIVERSITY CORPORATION EHIME UNIVERSITY, Matsuyama-shi (JP)

(72) Inventors: Toshio Yoshii, Matsuyama (JP); Kosei Takano, Fujimino (JP)

(73) Assignees: FUJITSU LIMITED, Kawasaki-shi (JP); NATIONAL UNIVERSITY CORPORATION EHIME UNIVERSITY, Matsuyama-shi (JP)

(21) Appl. No.: 15/491,063

(22) Filed: Apr. 19, 2017

(30) Foreign Application Priority Data
Apr. 21, 2016 (JP) 2016-085599

(51) Int. Cl. B60W 40/08

(52) U.S. Cl. CPC B60W 40/08; B60W 2040/0818

(57) ABSTRACT

A non-transitory computer-readable recording medium stores a determination program that causes a computer to execute a process including: acquiring at every predetermined time position information and speed information from a vehicle that travels a road; computing, by using the position information and the speed information, a distance by which the vehicle travels from a passage of a first spot at which the road changes from a downward slope to an upward slope to a spot at which the vehicle accelerates over a first predetermined value or a distance by which the vehicle travels from a passage of a second spot at which the road changes from an upward slope to a downward slope to a spot at which the vehicle decelerates over a second predetermined value; and determining degradation of driving ability of a driver who drives the vehicle based on the distance.

### CROSS-REFERENCE TO RELATED APPLICATION

This application is based upon and claims the benefit of priority of the prior Japanese Patent Application No. 2016-085599, filed on Apr. 21, 2016, the entire contents of which are incorporated herein by reference.

### FIELD

The embodiments discussed herein are related to a computer-readable recording medium, a determination method, and an information processing device.

### BACKGROUND

When a driver of a vehicle gets more and more tired, a series of driving behaviors of the driver such as recognition, determination, and operations becomes late, thereby becoming a cause of the occurrence of the accident. For example, in case of the transport industry, a load is transported in the distance in many cases, and thus a driving time may be prolonged. For this reason, any of driving control systems that use a digital tachograph sounds a warning when a continuous driving time elapses for a predetermined time, for example four hours.

Recently, there is known a method for detecting physical fatigue, mental fatigue, and sleepiness caused by a long drive to detect an alerting timing by using an index such as palpebration, a flicker, and a heart rate of a driver.

Patent Document 1: Japanese Laid-open Patent Publication No. 2009-009495

However, in the above technology, it is difficult to accurately detect the degradation of driving ability of a driver caused by fatigue, habituation, or the like.

In other words, the above technology employs a continuous driving time as a warning standard. However, even when a continuous driving time does not run beyond a predetermined time, a driver may be subject to detrimental influence with respect to a series of driving behaviors. The reason is because degrees at which fatigue is accumulated are different if drivers are different from each other, and degrees at which fatigue is accumulated are different depending on a physical condition or the like even in case of the same driver. As described above, in the above technology, even when fatigue of a driver is accumulated so as to be detrimental to a series of driving behaviors, a warning is not performed until a predetermined time elapses if a continuous driving time does not reach the predetermined time, and thus its warning can be delayed.

Because biological information such as palpebration, a flicker, and a heart rate is not easily measured during driving, has an individual difference, and includes noises, accuracy of measurement is not good. Moreover, because the burden of a driver increases by attaching a measuring device of a heart rate to the driver, it is not practical.

### SUMMARY

According to an aspect of the embodiments, a non-transitory computer-readable recording medium stores a determination program that causes a computer to execute a process including: acquiring at every predetermined time position information and speed information from a vehicle that travels a road; computing, by using the position information and the speed information, a distance by which the vehicle travels from a passage of a first spot at which the road changes from a downward slope to an upward slope to a spot at which the vehicle accelerates over a first predetermined value or a distance by which the vehicle travels from a passage of a second spot at which the road changes from an upward slope to a downward slope to a spot at which the vehicle decelerates over a second predetermined value; and determining degradation of driving ability of a driver who drives the vehicle based on the distance.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an entire configuration example of a system according to a first embodiment;

FIG. 2 is a diagram explaining a traveling behavior;

FIG. 3 is a functional block diagram illustrating the functional configuration of a driving control device according to the first embodiment;

FIG. 4 is a diagram illustrating an example of information stored in a sag standard database;

FIGS. 5A to 5C are diagrams illustrating examples of sags;

FIG. 6 is a diagram illustrating an example of information stored in a traveling information database;

FIG. 7 is a diagram explaining a degradation determination of performance;

FIG. 8 is a flowchart illustrating a flow of a process;

FIG. 9 is a functional block diagram illustrating the functional configuration of a driving control device according to a second embodiment;

FIG. 10 is a diagram illustrating an example of information stored in a statistical information database;

FIG. 11 is a diagram illustrating estimation results of parameters of a decelerating traveling distance and a continuous driving time;

FIG. 12 is a diagram illustrating a relationship between a decelerating traveling distance and a continuous driving time;

FIGS. 13A to 13C are diagrams illustrating examples of crests; and

FIG. 14 is a diagram illustrating a hardware configuration example.

### DESCRIPTION OF EMBODIMENTS

Preferred embodiments will be explained with reference to accompanying drawings. Moreover, the disclosed technology is not limited to the embodiments explained below. The embodiments explained below may be appropriately combined within a scope in which the combined embodiments do not contradict each other.

### [a] First Embodiment

Entire Configuration

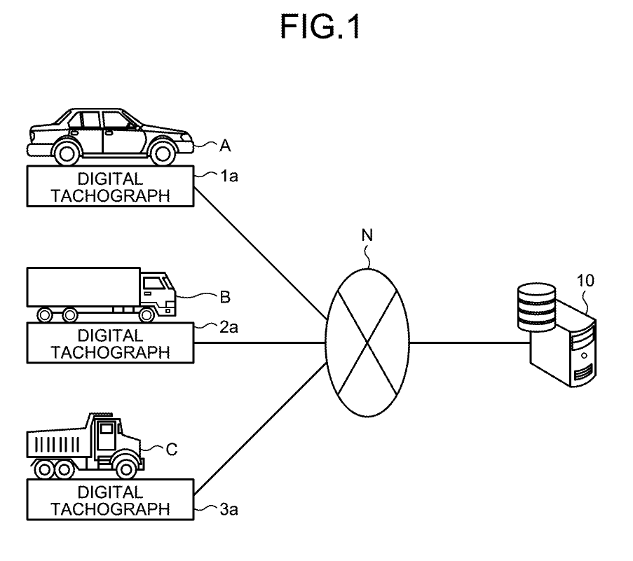

FIG. 1 is a diagram illustrating an entire configuration example of a system according to the first embodiment. A driving control system illustrated in FIG. 1 includes a driving control device 10 and digital tachographs 1a, 2a, and 3a. As an example of an on-vehicle device that sounds a warning against fatigue, a digital tachograph is illustrated in FIG. 1. However, a digital tachograph is only one example as described later, and thus the on-vehicle device may be another on-vehicle device. Moreover, the on-vehicle device may be provided outside the driving control system.

The digital tachographs 1a, 2a, and 3a are respectively mounted on a vehicle A, a vehicle B, and a vehicle C. The digital tachographs 1a, 2a, and 3a and the driving control device 10 are connected to one another via a network N to be communicable mutually. The network N can include, regardless of wired or wireless, a communication network of any type such as Internet, LAN (Local Area Network), and VPN (Virtual Private Network).

Each of the digital tachographs is a kind of an on-vehicle device mounted on a vehicle, and also is referred to as a tachograph. Hereinafter, when the digital tachographs 1a, 2a, and 3a are collectively referred, they may be simply referred to as “digital tachograph”.

As one embodiment, each digital tachograph can be connected via a connector and an electronic control unit (ECU) dedicated to a digital tachograph of a vehicle, which are not illustrated, in order to acquire a traveling record such as a speed and a distance. For example, each digital tachograph can acquire, as traveling data, a time-series change of a statutory traveling parameter such as a speed and a distance and also time-series data of position information including latitude and longitude via a global positioning system (GPS) receiver etc. that is not illustrated. Moreover, as an example, each digital tachograph can acquire traveling data in a predetermined sampling period, for example, at intervals of 0.5 seconds or less.

More specifically, each digital tachograph regularly transmits various types of traveling data on each vehicle that is a probe car to the driving control device 10. For example, the digital tachograph 1a transmits an identifier (ID), a position coordinate, a speed, an acceleration, an engine speed, an inter-vehicle distance, etc. of the vehicle A to the driving control device 10 every second. Moreover, a position coordinate is data per 0.1 seconds acquired from the GPS receiver including an external antenna of the vehicle A. A speed is data obtained by acquiring an instantaneous value in units of 0.1 km/h from a pulse signal of the vehicle.

In addition to the information, each digital tachograph can transmit a use history etc. of a service area and a parking area in one trip from start to stop of an engine, for example. For an acceleration, each digital tachograph can calculate it like acceleration (aᵢ)=(Vᵢ−Vᵢ−1)/t₍ᵢ₎ and notify it of the acceleration. Herein, “aᵢ” indicates an acceleration [m/s²] at a section “i”, “Vᵢ” indicates a speed [m/s] at the section “i”, and “tᵢ” indicates a time [s] from the inflow into a section “i−1” to the inflow into the section “i”.

The driving control device 10 is a computer that provides a driving management support service supporting driving management such as self-diagnosis of safe driving or guidance of safe driving by a driving manager etc., promotion of eco-drive and labor management by using traveling data acquired by the digital tachographs 1a, 2a, and 3a.

As one embodiment, the driving control device 10 can be implemented by installing in a desired computer a driving management support program for realizing the driving management support service as package software and online software. For example, the driving control device 10 may be implemented as a Web server for providing the driving management support service, or may be implemented by outsourcing as a cloud service for providing the driving management support service.

In the driving control device 10, because a function for sounding a warning against fatigue is the same as providing an existing similar driving management support service, a part on a warning against fatigue etc. will be mainly explained below. The present embodiment can be applied to any of a sag part and a crest part. Herein, as an example, a sag part will be mainly explained. In the present embodiment, a sag part may be referred to as a sag, and a crest part may be referred to as a crest.

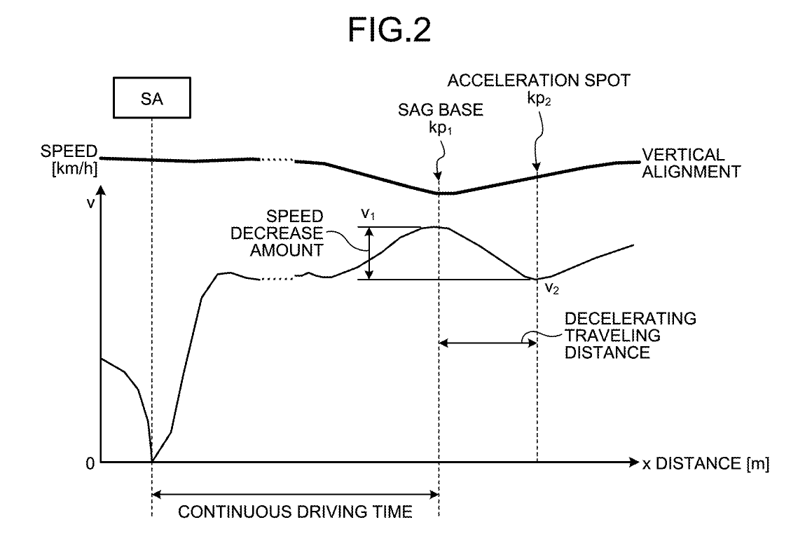

For example, the driving control device 10 performs an analysis in consideration of the change of a traveling behavior during the passing of a sag section for each driver. Herein, as an index indicating a traveling behavior, we focus attention on a decelerating traveling distance. FIG. 2 is a diagram explaining a traveling behavior. As illustrated in FIG. 2, the driving control device 10 specifies a spot (kp₂) at which acceleration is first started after the passing of a sag base (kp₁), and sets a distance between both spots as an index indicating a traveling behavior. A decelerating traveling distance is a traveling distance from a sag base to a spot at which acceleration is first performed when each vehicle travels a rising slope after the passing of the sag base while each vehicle is traveling a sag part on an express highway, and is defined with a decelerating traveling distance (L)=kp₂−kp₁. In FIG. 2, a time from a service area (SA) to the sag base can be defined as a continuous driving time, and a difference (dv=v₁−v₂) between a speed v₁ at the sag base (kp₁) and a speed v₂ at the acceleration spot (kp₂) can be defined as a speed decrease amount.

For each sag on an express highway in which a vehicle can travel freely with a speed not less than a constant value for example, the driving control device 10 computes and holds a decelerating traveling distance of the vehicle that has passed through this sag, and standardizes the decelerating traveling distance to generate a criterion. For example, the driving control device 10 can set, as a criterion, an average value of decelerating traveling distances of a vehicle that has passed through sags. Moreover, the driving control device 10 can generate a probability distribution such as a normal distribution by using the plurality of decelerating traveling distances acquired for the sags, and perform determination based on the probability distribution.

In this way, the driving control device 10 generates a criterion from the plurality of decelerating traveling distances measured for the sags in real time, compares the decelerating traveling distances of the vehicle measured in real time with the criterion, and specifies the change in the traveling behavior of the driver. Then, when the change in the traveling behavior of the driver is caused, the driving control device 10 determines the degradation of performance by fatigue and transmits a warning to the vehicle.

Functional Configuration

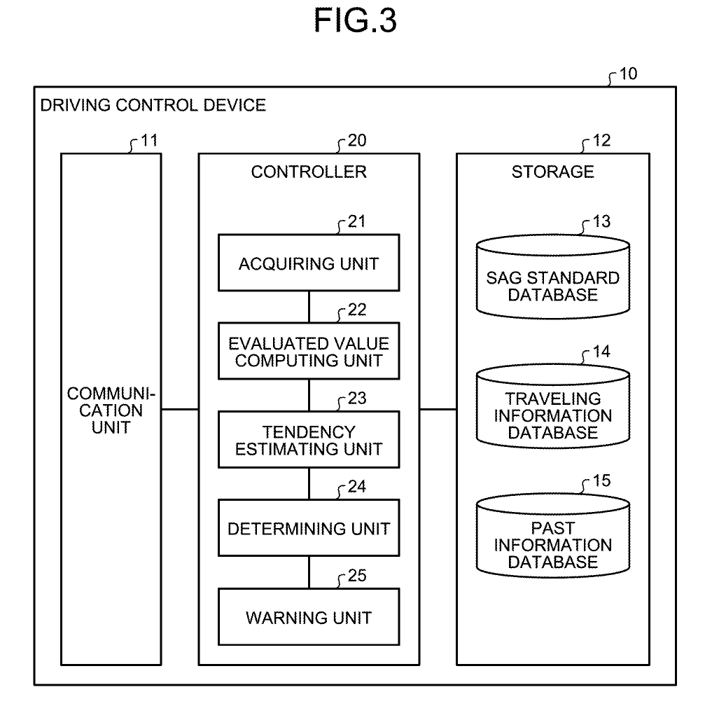

FIG. 3 is a functional block diagram illustrating the functional configuration of the driving control device according to the first embodiment. As illustrated in FIG. 3, the driving control device 10 includes a communication unit 11, a storage 12, and a controller 20.

The communication unit 11 is an example of a wireless communication interface that controls communication with each digital tachograph. For example, the communication unit 11 receives various types of traveling data from each digital tachograph, and transmits a message such as a warning and a display instruction for the message to each digital tachograph.

The storage 12 is an example of a storage device such as a memory and a hard disk, and stores therein a sag standard database 13, a traveling information database 14, and a past information database 15.

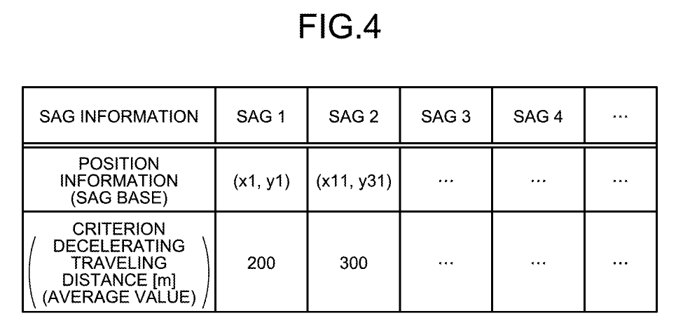

The sag standard database 13 is a database that stores a criterion of a decelerating traveling distance for each sag. FIG. 4 is a diagram illustrating an example of information stored in the sag standard database 13. As illustrated in FIG. 4, the sag standard database 13 stores “sag information, position information (sag base), criterion” in association with one another. The “sag information” to be stored herein is an identifier etc. specifying a sag. The “position information (sag base)” is the position of a sag, namely, the position coordinate of a sag base in FIG. 2.

The “criterion” is a criterion generated by using decelerating traveling distances of a plurality of vehicles that have previously traveled a corresponding sag. For example, the setting of a criterion can be performed, after computing an average and a standard deviation by using the decelerating traveling distances of the plurality of vehicles, based on a specified probability distribution indicated by the average and standard deviation. The probability distribution to be stored herein can be generated from a past traveling history, or a probability distribution to be assumed can previously set.

As another example, an average value etc. of the decelerating traveling distances of the plurality of vehicles can be employed. An average value is illustrated in FIG. 4. In case of an example of FIG. 4, it is illustrated that the position coordinate of a sag base of “sag 1” is (x1, y1) and an average value of decelerating traveling distances after passing through “sag 1” is “200 m”.

A decelerating traveling distance that is used for the generation of a criterion can be selected in accordance with a vehicle that is a target for driving management. For example, original data for generating a criterion can be narrowed down as follows: a decelerating traveling distance of the same-level vehicle as the weight of a vehicle of a management target; a decelerating traveling distance of a vehicle that is driven by the same-year driver as a driver of a vehicle of a management target; a decelerating traveling distance of a vehicle that is driven by the same-level driver as a driving record of a vehicle of a management target; and a decelerating traveling distance of a vehicle measured day and night when a vehicle of a management target travels. Herein, the same-level and same-year do not mean completely-identical. In other words, for example, like ±10 kg and ±5 years old, the same-level and same-year can have a certain level of width.

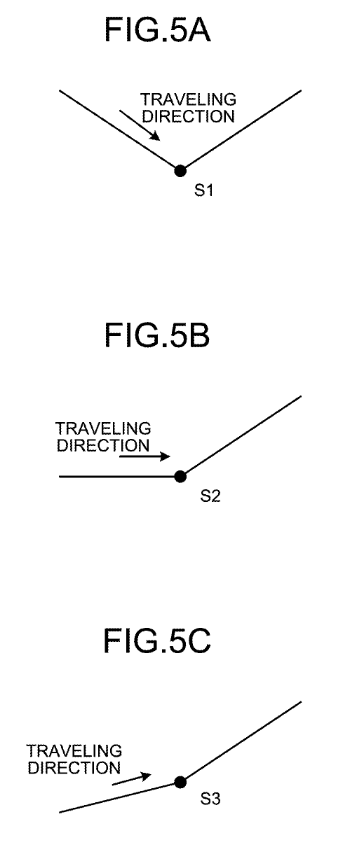

Herein, an example of a sag in the present embodiment will be explained. FIGS. 5A to 5C are diagrams illustrating examples of sags. A sag illustrated in FIG. 5A is a downward slope toward a sag base S1, and becomes an upward slope after passing through the sag base S1. A sag illustrated in FIG. 5B is flat toward a sag base S2, and becomes an upward slope after passing through the sag base S2. A sag illustrated in FIG. 5C is a gentle upward slope having small inclination toward a sag base S3, and becomes a steep upward slope having large inclination after passing through the sag base S3. Any sag illustrated in the drawings can be processed as a sag in the present embodiment.

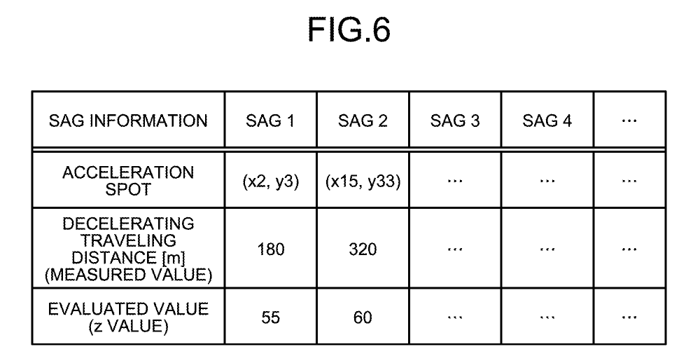

The traveling information database 14 is a database that stores driving data when each vehicle passes through each sag. FIG. 6 is a diagram illustrating an example of information stored in the traveling information database 14. As illustrated in FIG. 6, the traveling information database 14 stores therein “sag information, acceleration spot, decelerating traveling distance (measured value), evaluated value (z value)” in association with one another.

The “sag information” to be stored herein is an identifier etc. specifying a sag. The “acceleration spot” is a spot first accelerated after passing through a sag, namely the position coordinate of the acceleration spot (kp₂) in FIG. 2. The “decelerating traveling distance (measured value)” is, when a vehicle travels a rising slope after passing through a sag base during traveling a sag part on an express highway, a measured value of a traveling distance from the sag base to a spot at which acceleration is first performed. The “evaluated value” indicates a comparison result with a criterion corresponding to this sag. For example, when a criterion is an average value, a difference between an average value and a measured value is stored as an “evaluated value”.

As another example, when a criterion is a probability distribution such as a normal distribution, a “z” value is stored as an “evaluated value”. FIG. 6 is an example of driving information of the vehicle A and illustrates an example of a “z” value that is used as an evaluated value.

In the example of FIG. 6, it is illustrated that an acceleration spot after passing through a “sag 1” is (x2, y3), a measured value of a decelerating traveling distance from the sag base of the sag 1 to the acceleration spot is “180 m”, and the measured value corresponds to the z value “55” in the normal distribution for the sag 1.

The past information database 15 is a database that stores passage information when passing through a sag every vehicle, every driver, or every road. In other words, the past information database 15 stores a passage history of a sag. Similarly to FIG. 6, information to be stored is “sag information, acceleration spot, decelerating traveling distance (measured value), evaluated value”, etc.

The controller 20 is a processing unit that manages the whole process of the driving control device 10, and includes an acquiring unit 21, an evaluated value computing unit 22, a tendency estimating unit 23, a determining unit 24, and a warning unit 25. The controller 20 can be realized by a central processing unit (CPU), a micro processing unit (MPU), etc. Moreover, the controller 20 can be realized by hard-wired logic such as ASIC (Application Specific Integrated Circuit) and FPGA (Field Programmable Gate Array). For example, the acquiring unit 21, the evaluated value computing unit 22, the tendency estimating unit 23, the determining unit 24, and the warning unit 25 are an example of an electronic circuit of a processor or an example of a process that is executed by a processor.

The acquiring unit 21 is a processing unit that acquires probe data from each vehicle. Specifically, the acquiring unit 21 receives probe data from each vehicle every second, for example, and extracts traveling data such as an identifier (ID), a position coordinate, a speed, an acceleration, an engine speed, and an inter-vehicle distance of the vehicle from the received probe data. Then, the acquiring unit 21 notifies the evaluated value computing unit 22 of the acquired traveling data.

When the travel of the sag is detected, the evaluated value computing unit 22 is a processing unit that computes a measured value and an evaluated value and stores them in the traveling information database 14. Specifically, the evaluated value computing unit 22 generates the traveling information database 14 in accordance with the information stored in the sag standard database 13 and the acquired traveling data.

For example, when acquiring a position coordinate identical with the position information of the sag 1 from the probe data of the vehicle A, the evaluated value computing unit 22 determines that the vehicle A is traveling the sag 1 and saves each traveling data acquired from the probe data as a start spot. After that, the evaluated value computing unit 22 acquires and monitors an acceleration and a position coordinate from the probe data transmitted from the vehicle A at any time, and saves a position coordinate of probe data including an acceleration not less than a predetermined value as an end spot.

Then, the evaluated value computing unit 22 computes a distance from the position coordinate of the start spot to the position coordinate of the end spot as a decelerating traveling distance (measured value). After that, the evaluated value computing unit 22 stores the computed decelerating traveling distance (measured value) in the traveling information database 14 as the measured value of the sag 1 of the vehicle A. In this way, the acquiring unit 21 computes and stores a measured value of each sag for each vehicle. Moreover, a decelerating traveling distance (measured value) can be computed by using well-known various techniques. For example, a decelerating traveling distance (measured value) can be computed by using a coordinate of a start spot and a coordinate of an end spot, or can be computed by using a time from a start spot to an end spot, a speed, an acceleration, etc.

The detection of an end spot can be performed by using various techniques. For example, the evaluated value computing unit 22 can specify, as an end spot, a spot at which an absolute value of an acceleration included in probe data becomes more than a predetermined value, a spot at which an absolute value of a change from the previous acceleration to the present acceleration becomes more than a predetermined value, a spot at which a sign of an acceleration is changed from the previous acceleration, a spot at which a change is performed from deceleration to acceleration, and the like.

Next, upon storing the decelerating traveling distance (measured value), the evaluated value computing unit 22 computes an evaluated value by using the measured value and the criterion, and stores the evaluated value in the traveling information database 14. For example, when a probability distribution such as a normal distribution is stored in the sag standard database 13 as the criterion of the sag 1, the evaluated value computing unit 22 computes the z value of the decelerating traveling distance (measured value) for the sag 1 by using the probability distribution. The evaluated value computing unit 22 then stores the z value in the traveling information database 14 as the evaluated value of the sag 1.

As another example, when an average value is stored in the sag standard database 13 as the criterion of the sag 1, the evaluated value computing unit 22 computes a difference between the average value and the decelerating traveling distance (measured value) for the sag 1. The evaluated value computing unit 22 then stores the computed difference in the traveling information database 14 as the evaluated value of the sag 1.

In this way, the evaluated value computing unit 22 computes, for each sag, an evaluated value obtained by comparing a criterion and a measured value and stores the evaluated value in the traveling information database 14 whenever the decelerating traveling distance (measured value) is stored.

The tendency estimating unit 23 is a processing unit that estimates a tendency of a decelerating traveling distance of a driver for each vehicle. Specifically, the tendency estimating unit 23 estimates a tendency of a decelerating traveling distance of that day for each vehicle when evaluated values for a predetermined number of times are stored for the sag of the traveling information database 14. In other words, the tendency estimating unit 23 estimates, for each vehicle, a tendency of a decelerating traveling distance of that day from real-time measured values after the vehicle starts.

For example, when the z values are computed for the sags 1 to 30 for the vehicle A, the tendency estimating unit 23 acquires 30 z values from the traveling information database 14. The tendency estimating unit 23 then computes an average and a standard deviation by using the acquired 30 z values, and generates a probability distribution such as a normal distribution indicated by the average and standard deviation. After that, the tendency estimating unit 23 notifies the determining unit 24 of the generated probability distribution as the tendency of the decelerating traveling distance for the vehicle A.

As another example, when average values are computed for the sags 1 to 30 for the vehicle A, the tendency estimating unit 23 acquires 30 average values from the traveling information database 14. The tendency estimating unit 23 further computes an average value of the acquired 30 average values. After that, the tendency estimating unit 23 can notify the determining unit 24 of the computed average value as the tendency of the decelerating traveling distance for the vehicle A.

The determining unit 24 is a processing unit that determines the degradation of driving ability (hereinafter, may be referred to as “performance”) by using the tendency specified by the tendency estimating unit 23 and a measured value measured in real time. Because a tendency has been specified by using decelerating traveling distances (measured values) of the sags 1 to 30 for the vehicle A when being explained by using the example, the determining unit 24 determines the degradation of driving ability by using decelerating traveling distances (measured values) from a sag 31.

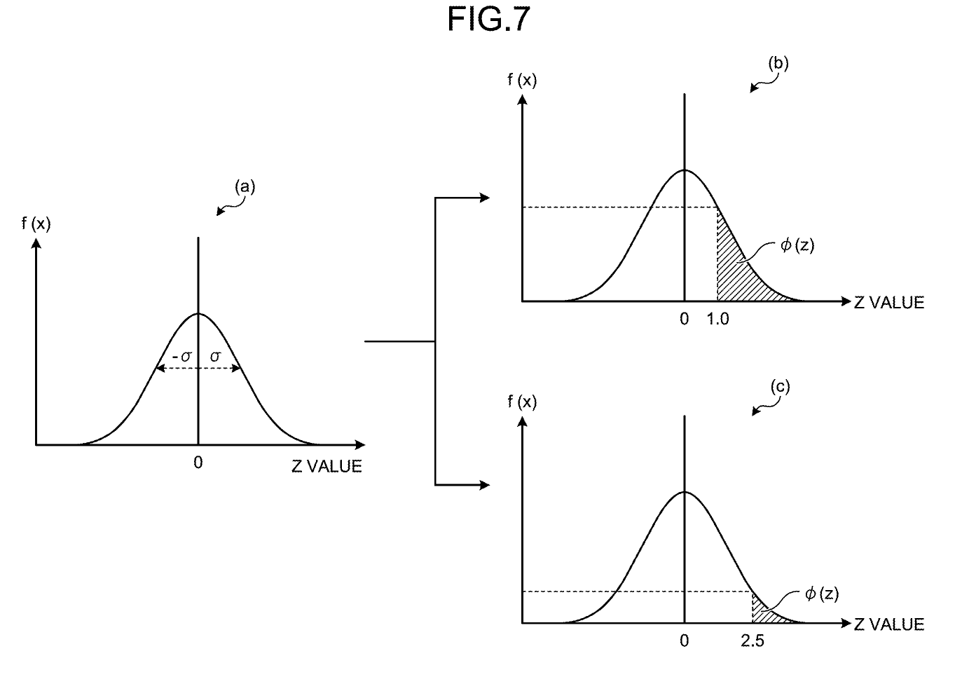

FIG. 7 is a diagram explaining a degradation determination of performance. For example, it is assumed that a normal distribution of an average (φ and a standard deviation (σ) is supposed by the tendency estimating unit 23 as a tendency as illustrated in (a) of FIG. 7. At this time, the determining unit 24 computes a probability with which a z value for the sag 31 is generated, and determines the degradation of driving ability assuming that the shift is performed to a distribution different from the normal distribution of (a) of FIG. 7 when the probability is not more than a threshold.

For example, the determining unit 24 computes an area φ(z), when an evaluated value for the sag 31 is a Z value, in accordance with a probability density function f(x). Then, the determining unit 24 determines that a possibility with which driving ability is decreasing is low when the area φ(z) is larger than a threshold, determines that a possibility with which driving ability is decreasing is high when the area φ(z) is not more than the threshold, and notifies the warning unit 25 of the result.

Specifically, it is assumed that an evaluated value (Z) for the sag 31 is Z=1.0*z value. In this case, as illustrated in (b) of FIG. 7, the determining unit 24 computes an area φ(z) in case of Z=1.0 in accordance with the probability density function f(x). In this case, because the area φ(z) becomes larger than a threshold (0.025), the determining unit 24 determines that a possibility with which driving ability is decreasing is low.

On the other hand, it is assumed that an evaluated value (Z) for the sag 31 is Z=2.5*z value. In this case, as illustrated in (c) of FIG. 7, the determining unit 24 computes an area φ(z) in case of Z=2.5 in accordance with the probability density function f(x). In this case, the determining unit 24 determines that a possibility with which driving ability is decreasing is high because the area φ(z) becomes smaller than the threshold (0.025).

As described above, when detecting traveling data for which an occurrence probability in a normal distribution generated from real-time traveling data becomes low, the determining unit 24 determines that a possibility with which driving ability is decreasing is high. In other words, when an excessively long decelerating traveling distance (measured value) is detected or when an excessively short decelerating traveling distance (measured value) is detected, the determining unit 24 determines that a possibility with which driving ability is decreasing is high.

As another example, when a difference between a measured value measured in real time and an average value estimated as a tendency is not less than a threshold, the determining unit 24 can determine that driving ability is decreasing.

When once detecting the degradation of driving ability, the determining unit 24 can instruct the warning unit 25 to alarm a warning. Alternatively, when continuously detecting the degradation of driving ability multiple times, the determining unit 24 can instruct the warning unit 25 to alarm a warning. In other words, the timing of a warning can be optionally set and changed.

The warning unit 25 is a processing unit that outputs an alert on fatigue when the degradation or decrease of driving ability is detected by the determining unit 24. As an example of the alert, the warning unit may output a beep sound, or may output the following message by using voice or display. For example, the warning unit can output a message such as “Is it tired?” and “Please take a break because there is a possibility with which fatigue affects ability to drive safely”. Moreover, as an example of the output destination of the alert, an on-vehicle display device, an on-vehicle speaker, etc. can be selected as an output destination, and also an information processing device to be used by a driving manager can be selected as an output destination.

It is possible to promote a break at an appropriate timing by outputting an alert on fatigue as described above. Furthermore, because each driver brings into a drive in the sufficient state of the rest when each driver takes a break at an appropriate timing, a probability of the occurrence of the accident is reduced, and further a time for a series of driving behaviors of recognition, determination, and operations is shortened. As a result, we can expect the relaxation of a traffic jam in a sag and a crest.

Flow of Process

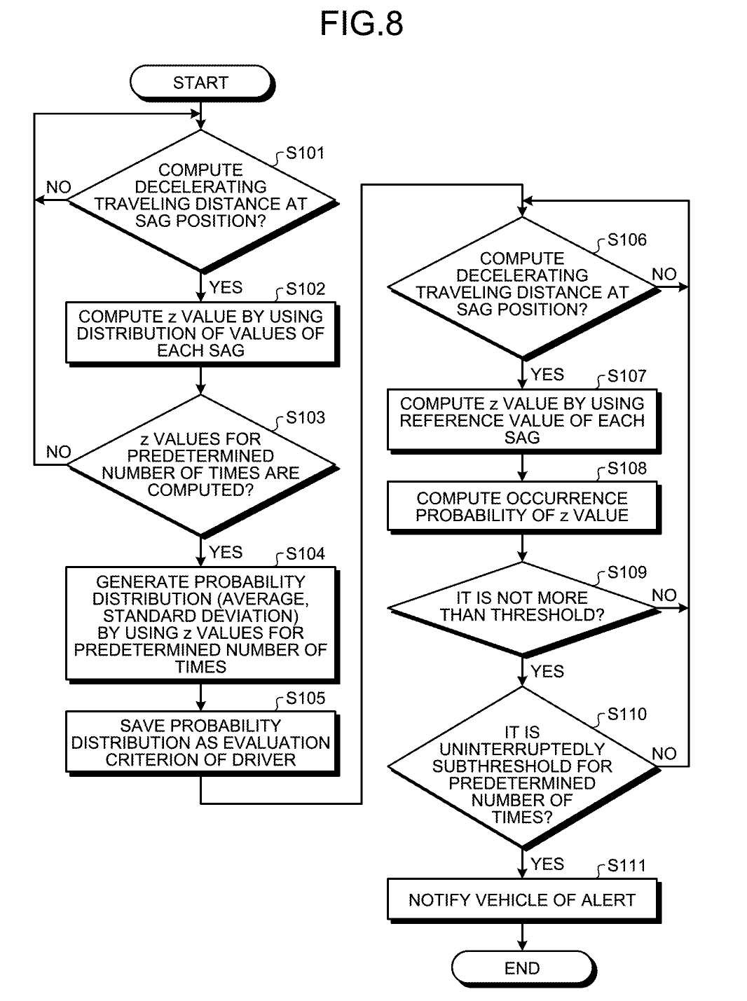

FIG. 8 is a flowchart illustrating a flow of a process. Herein, a use example of a normal distribution will be explained instead of the average value. A process executed herein is performed for each vehicle, namely, for each driver.

As illustrated in FIG. 8, when computing a decelerating traveling distance at a sag position in accordance with probe data acquired by the acquiring unit 21 (S101: Yes), the evaluated value computing unit 22 of the driving control device 10 computes a z value by using a distribution of values of a corresponding sag stored in the sag standard database 13 and stores the z value in the traveling information database 14 (S102).

Then, the evaluated value computing unit 22 repeats Step S101 and the next steps until z values for a predetermined number of times are computed (S103: No).

After that, when z values for the predetermined number of times are computed (S103: Yes), the tendency estimating unit 23 generates a probability distribution (normal distribution) of the z values by using the z values for the predetermined number of times (S104). Next, the tendency estimating unit 23 saves the generated probability distribution as an evaluation criterion of the driver (S105).

After that, when computing a decelerating traveling distance at a sag position in accordance with the probe data acquired by the acquiring unit 21 (S106: Yes), the evaluated value computing unit 22 computes a z value by using a reference value of the corresponding sag stored in the sag standard database 13 and stores the z value in the traveling information database 14 (S107).

Next, the determining unit 24 computes, by using the saved probability distribution and the z value computed in Step S107, an occurrence probability of the z value (S108). Then, when the computed occurrence probability is larger than a threshold (S109: No), the process returns to Step S106 and the next steps are performed.

On the other hand, when the computed occurrence probability is not more than the threshold (S109: Yes), the determining unit 24 determines whether the subthreshold occurrence probabilities are continuously detected for a predetermined number of times (S110).

Herein, when the subthreshold occurrence probability is less than the predetermined number of times (S110: No), the process returns to Step S106 and the next steps are performed. On the other hand, when the subthreshold occurrence probabilities are detected continuously for the predetermined number of times (S110: Yes), the warning unit 25 notifies the vehicle of an alert (S111).

One Aspect of Effect

As described above, the driving control device 10 can generate a criterion in accordance with a decelerating traveling distance at a sag position acquired in real time, and detect the degradation of driving ability by using this criterion. Therefore, because a criterion in which the situation of a driver of that day is reflected can be generated for each trip, the driving control device 10 can detect the degradation of driving ability according to a health condition and a fatigue condition of the driver. As a result, the driving control device 10 can improve a detection accuracy of the degradation of driving ability.

Because the degradation of driving ability can be detected without using biological information such as palpebration, a flicker, and a heart rate, the driving control device 10 can suppress a burden other than a drive. Moreover, because new hardware such as a sensor is not used, reduction in cost can be expected.

Herein, in the first embodiment, it has been explained that a criterion is generated by using a decelerating traveling distance at a sag position measured in real time. However, the present embodiment is not limited to this. For example, when a driver is scheduled to travel an express highway X and a traveling record of each sag on the highway X at the time of previously passing through the highway X is stored, it is possible to previously generate a criterion by using the past traveling record.

For example, the tendency estimating unit 23 generates a normal distribution and saves it as a criterion by using z values of sags X1 to X90 located in the highway X. After that, when a decelerating traveling distance at a sag position is computed after starting the travel on the highway X, the determining unit 24 computes an occurrence probability of the decelerating traveling distance with the same method as that of the embodiment. In this way, the driving control device 10 can determine the degradation of driving ability from the driving at the first sag position on the highway X. As a result, because the degradation of driving ability can be determined from immediately after a startup, the driving control device 10 can early detect physical deconditioning etc. of the driver.

In this example, when a criterion is previously generated, it has been explained that the criterion is generated by using a traveling history of the exact same highway as the highway X to be scheduled to travel. However, the present embodiment is not limited to this. For example, a criterion can be generated by using a traveling history of a highway having a shape similar to the highway X, a traveling history of a highway to which the occurrence tendency of sags included in the highway X is similar, a traveling history of a highway having sags of the same as the number of sags included in the highway X, and the like. Moreover, a past traveling history to be employed can be narrowed down depending on a time zone to be traveled, the type of a vehicle to be traveled, and the like. Even in this case, it is possible to determine the degradation of driving ability from immediately after a startup and to early detect physical deconditioning of the driver.

### [b] Second Embodiment

In the first embodiment, it has been explained that a driver can be appropriately notified of the timing of a break by detecting the degradation of driving ability in real time. On the contrary, the driving control device 10 may compute the timing of a break from a past driving history, for example, and notify a driver of it.

Therefore, in the second embodiment, an example in which the timing of a break is computed from a past driving history and a driver is notified of it will be explained. Because the entire configuration is similar to that of FIG. 1, detailed descriptions are omitted.

Functional Configuration

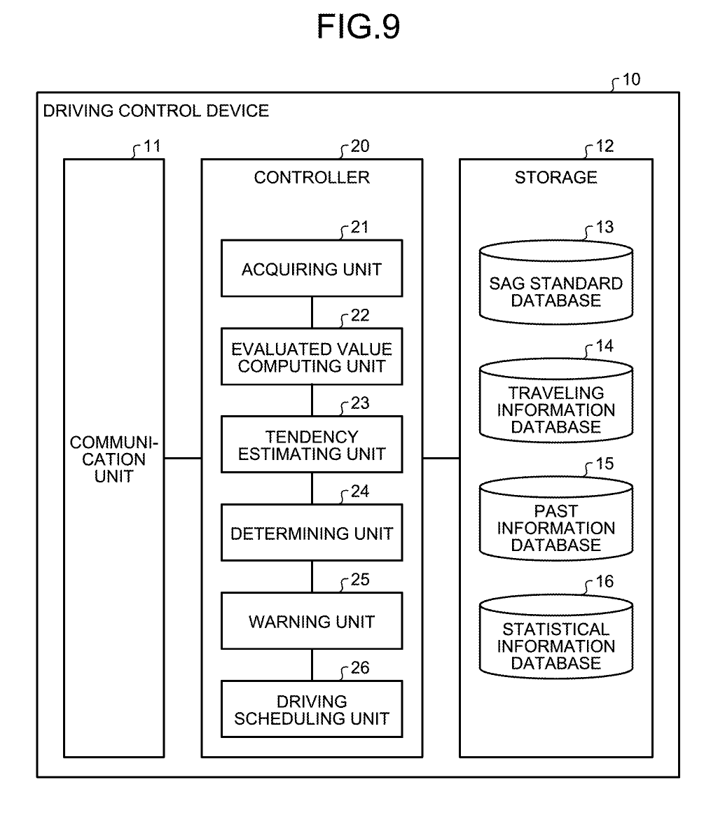

FIG. 9 is a functional block diagram illustrating the functional configuration of the driving control device 10 according to the second embodiment. As illustrated in FIG. 9, the driving control device 10 includes the communication unit 11, the storage 12, and the controller 20.

Unlike the first embodiment, the driving control device 10 illustrated in FIG. 9 further includes a statistical information database 16 and a driving scheduling unit 26. Because the other processing units are similar to those of the first embodiment, detailed descriptions are omitted.

The statistical information database 16 is a database that collectively stores a traveling history for each sag on each highway irrespective of a driver and a vehicle, and stores a relationship between a continuous driving time and a decelerating traveling distance for each sag. For example, the statistical information database 16 stores a relationship between a continuous driving time and a decelerating traveling distance for a vehicle that travels each sag from Iyo-Saijo Interchange to Sendai Interchange of the downline of Matsuyama Expressway crossing the East and West of Ehime-ken using Takamatsunishi Interchange of Kagawa-ken as a starting point.

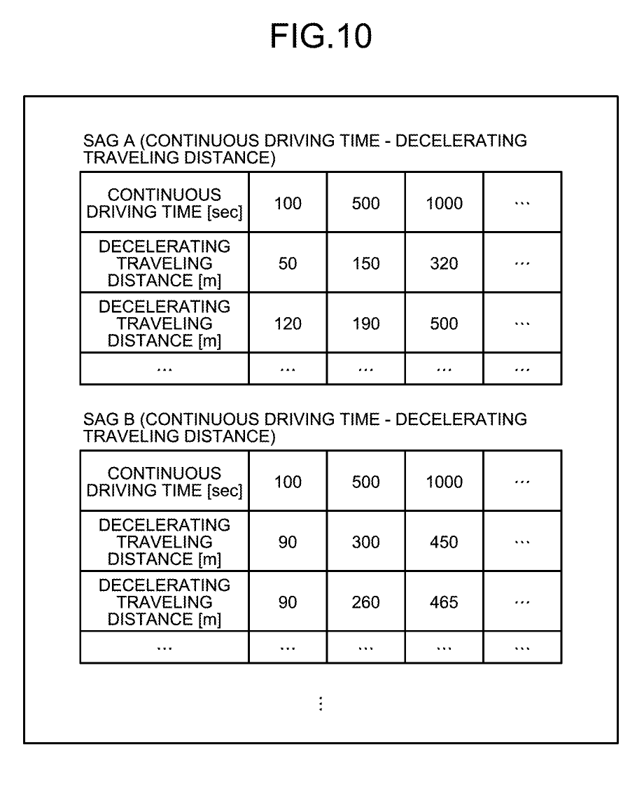

FIG. 10 is a diagram illustrating an example of information stored in the statistical information database 16. As illustrated in FIG. 10, the statistical information database 16 stores a relationship between a continuous driving time and a decelerating traveling distance for each sag such as a sag A and a sag B. More specifically, the statistical information database 16 registers, for the sag A, 50 m, 120 m, etc. as a history as a decelerating traveling distance when a vehicle of which a continuous driving time is zero to 100 seconds travels the sag A, and further registers 150 m, 190 m, etc. as a history as a decelerating traveling distance when a vehicle of which a continuous driving time is 101 to 500 seconds travels the sag A.

The driving scheduling unit 26 is a processing unit that estimates a continuous driving time recommended as a break timing in accordance with the statistical information stored in the statistical information database 16 to generate a driving plan. Herein, the driving scheduling unit 26 checks a relationship between a continuous driving time and an index indicating a traveling behavior of a driver, and performs an analysis with a goal of grasp of an impact that a continuous driving time has on a traveling behavior by modelization.

Herein, we consider a time-series change for a relationship between a continuous driving time and each traveling behavior index. In the early driving stage in which a driver does not get tired, it is expected that an index indicating a traveling behavior keeps a constant value. It is considered that it arrives at a stage at which an index value is suddenly changed by the gradual appearance of driver fatigue. In other words, the change of behavior becomes larger as a continuous driving time becomes longer. However, supposing that the increase is not a monotonic increase, it is considered that the reaction of the behavior of a vehicle is not largely changed up to an inflection point, and thus it is expected that a change is largely made after a certain inflection point.

Therefore, the driving scheduling unit 26 performs an analysis by using a polygonal line regression model. The model is an especially effective technique when explanatory variables are distributed over some different groups and indicate different relationships between the divided sections. Herein, a boundary (threshold) of a line segment is referred to as an inflection point. In the estimation of parameters, by using a least squares method, three regression lines are applied to sections made and divided to adapt to a data set as much as possible while minimizing a square-sum of a difference (residual) between an observed value and a calculated value of a dependent variable. Therefore, it becomes Equation (1) when it is formulated.

$${y}_{j} = \{ \begin{matrix}α + {β}_{1} & {( x \leq {k}_{1} )}_{1} \\ α + {β}_{1} {k}_{1} + {β}_{2} ( x - {k}_{1} ) & ( {k}_{1} < x \leq {k}_{2} ) \\ α + {β}_{1} {k}_{3} + {β}_{2} ( {k}_{2} - {k}_{1} ) + {β}_{3} ( x - {k}_{2} ) & ( {k}_{2} < x )\end{matrix} \qquad ( 1 )$$

Herein, y is a dependent variable (decelerating traveling distance (m)), x is a continuous driving time (s), k is an inflection point (s), and α and β are parameters. They are calculated based on the acquired data. Moreover, in the selection of an optimum model, a continuous driving time is divided every 500(s), estimation is performed for each combination, and a model in which a value of the least square error is the minimum among them is selected as an optimum model.

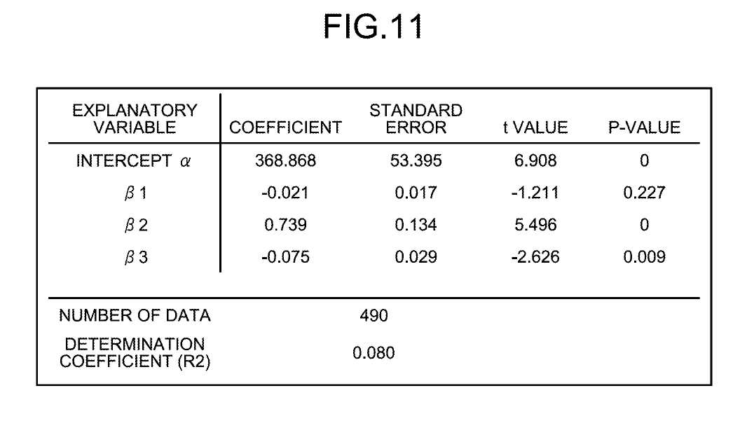

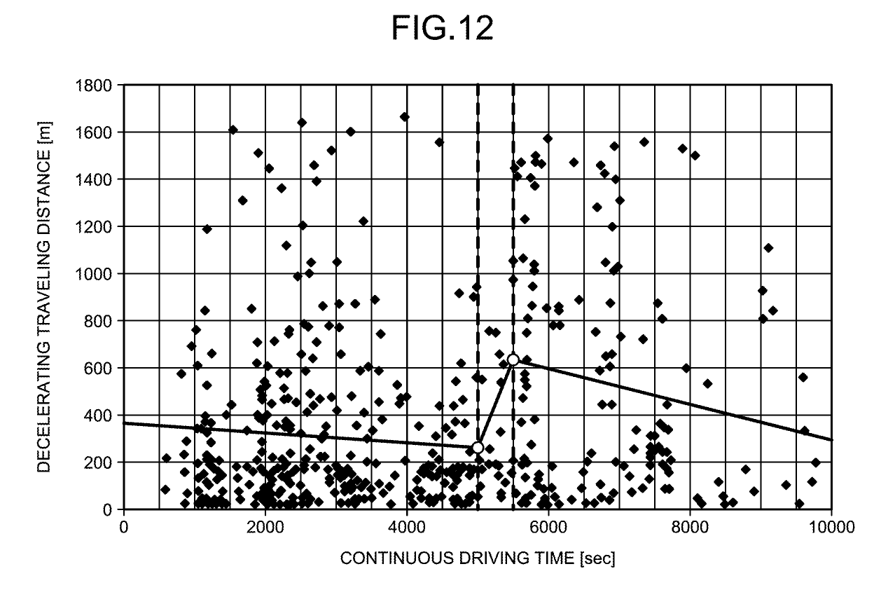

FIG. 11 is a diagram illustrating an estimation result of parameters of a decelerating traveling distance and a continuous driving time. FIG. 12 is a diagram illustrating a relationship between a decelerating traveling distance and a continuous driving time, and is a graph made by the obtained regression formula.

As illustrated in FIGS. 11 and 12, as the results of the analysis, when there is a combination of a first inflection point k₁=5000 seconds of a continuous driving time and a second inflection point k₂=5500 seconds thereof, the driving scheduling unit 26 obtains the highest determination coefficient value (R2=0.080). As indicated by the result, when the continuous driving time becomes 5000 seconds, an increased amount of the decelerating traveling distance, namely, the inclination of a regression line gives rise to a change. Specifically, in the section of 5000-5500 seconds, a coefficient value β₂ significantly indicates a positive value. Moreover, in the section over 5500 seconds, a result indicating a negative coefficient value is obtained.

From these estimation results, when a continuous driving time exceeds a predetermined time, the driving scheduling unit 26 specifies that a decelerating traveling distance tends to increase along with the increase of a driving time. In other words, when a continuous driving time exceeds a predetermined time, the driving scheduling unit can specify that a change is provoked in a traveling behavior. Therefore, when the continuous driving time exceeds 5000 seconds, the driving scheduling unit 26 instructs the warning unit 25 to alarm a warning. As a result, the warning unit 25 outputs a message promoting a break etc. when the continuous driving time exceeds 5000 seconds without stopping at a service area etc.

One Aspect of Effect

As described above, the driving control device 10 can promote a break at an appropriate timing. Because each driver brings into a drive in the sufficient state of the rest when a break is taken by each driver at an appropriate timing, a probability of the occurrence of the accident is reduced, and further a time for a series of driving behaviors of recognition, determination, and operations is shortened. As a result, we can expect the relaxation of a traffic jam in a sag and a crest.

In the second embodiment, it has been explained that the statistical information database 16 stores a relationship between a continuous driving time and a decelerating traveling distance for a vehicle that travels each sag in a corresponding section. However, it is possible to improve the calculation precision of a threshold of a continuous driving time by segmentalization and storing. For example, the statistical information database 16 can store the weight of a vehicle that travels each sag in a corresponding section, a driving record of a driver, the night and day, and the like in association with one another, and select traveling data in accordance with the situation of a driving plan.

### [c] Third Embodiment

It has been explained about the embodiments of the present invention till now. The present invention may be practiced by various different configurations in addition to the embodiments described above.

Digital Tachograph

In the above embodiments, it has been explained that the driving control device 10 determines the degradation of performance related to fatigue etc. However, the present embodiments are not limited to this. A digital tachograph of each vehicle illustrated in FIG. 1 or another on-vehicle device can also perform the determination. In other words, it is sufficient that an on-vehicle device can acquire position information and speed information. Each the process may performed by mounting each function part illustrated in FIGS. 3 and 9 on a drive recorder. Moreover, an on-vehicle device is not necessarily a device for a business vehicle. Therefore, each the process may be also performed by mounting each function part illustrated in FIGS. 3 and 9 on a navigation device etc.

Crest

In the embodiments, a sag has been explained as an example. However, the embodiments are not limited to this. The same process can be also performed at a crest etc. In case of a crest, the embodiments are different from a point that does not employ a distance from the passage of a crest to its acceleration, but employs a distance from the passage of a crest to its deceleration. However, the same process may be employed.

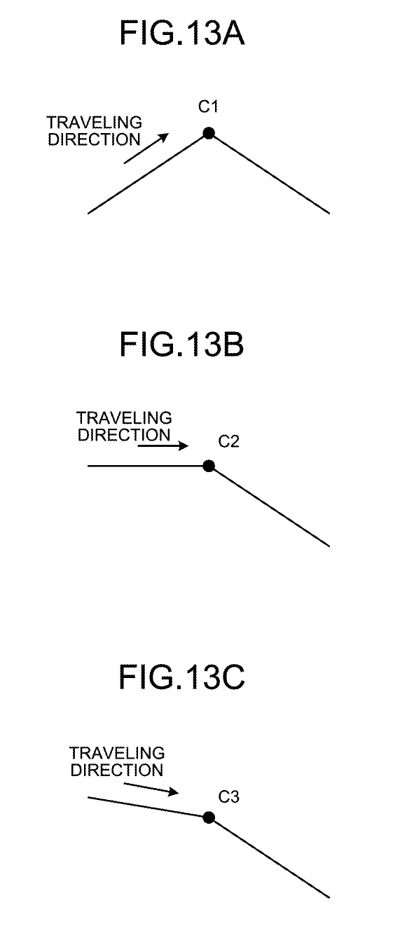

FIGS. 13A to 13C are diagrams illustrating examples of crests. A crest illustrated in FIG. 13A is an upward slope toward a crest top C1 and becomes a downward slope after passing through the crest top C1. A crest illustrated in FIG. 13B is flat toward a crest top C2 and becomes a downward slope after passing through the crest top C2. A crest illustrated in FIG. 13C is a gentle downward slope having small inclination toward a crest top C3 and becomes a steep downward slope having large inclination after passing through the crest top C3. In the present embodiment, any crest illustrated in the drawings can be processed as a crest.

Target History

In the embodiments, it has been explained that a tendency is specified when the z values of 30 decelerating traveling distances (measured values) are computed. However, the embodiments are not limited to this. For example, a tendency can be specified by using the z value of the computed decelerating traveling distance (measured value) when a predetermined time has elapsed from the start of a travel. Moreover, the driving control device 10 can also perform a process by using a deviation value instead of a z value.

Standardization

In the embodiments, it has been explained that a decelerating traveling distance (actual value) of a corresponding vehicle is evaluated by using a criterion of each sag and then a criterion is generated by using this evaluated value. However, the embodiments are not limited to this. For example, a criterion can be generated by using only a decelerating traveling distance (actual value) of a corresponding vehicle without using a criterion of each sag.

The driving control device 10 computes, at any time during the travel of a vehicle, a decelerating traveling distance (actual value) when the vehicle travels a sag and an accelerating traveling distance (actual value) from the travel of a crest of the vehicle to its acceleration. Then, when computing a decelerating traveling distance (actual value) and an accelerating traveling distance (actual value) exceeding a threshold, the driving control device 10 can transmit an alert.

The driving control device 10 generates a probability distribution such as a normal distribution from a past history for each sag, and computes, in accordance with the probability distribution, computes a probability with which a distance computed at the time of passage of a sag is generated. Then, when the probability is not more than a threshold, the driving control device 10 can determine that driving ability is decreasing. Moreover, in addition to a measured value, when a z value computed each time a vehicle travels a sag is not more than a first threshold or is not less than a second threshold, the driving control device 10 can determine that driving ability is decreasing.

Dispersion and Integration

Each component of each device illustrated in the drawings is not necessarily constituted physically as illustrated in the drawings. In other words, the specific configuration of dispersion/integration of each device is not limited to the illustrated configuration. Therefore, all or a part of each device can be dispersed or integrated functionally or physically in an optional unit in accordance with various types of loads or operating conditions. For example, the acquiring unit 21, the evaluated value computing unit 22, the tendency estimating unit 23, the determining unit 24, the warning unit 25, or the driving scheduling unit 26 may be connected to the driving control device 10 via the network as an external device of the driving control device 10. Moreover, other devices may respectively include the acquiring unit 21, the evaluated value computing unit 22, the tendency estimating unit 23, the determining unit 24, the warning unit 25, and the driving scheduling unit 26, and be connected to the network and cooperate with one another so as to realize the functions of the driving control device 10.

Determination Program

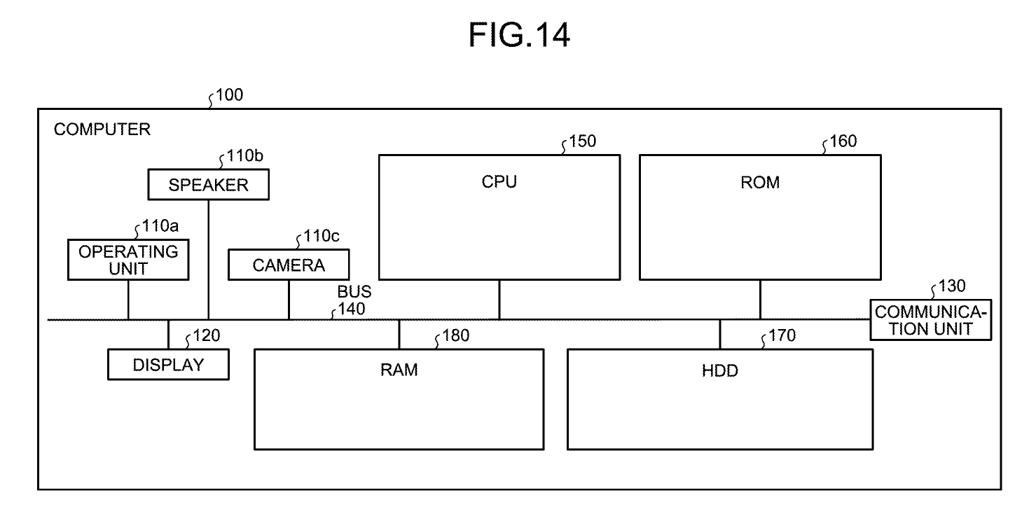

Various types of processes explained in the above embodiments can be realized by executing a previously-prepared program by using a computer such as a personal computer and a workstation. Therefore, an example of a computer performing a determination program having the same functions as those of the above embodiments will be explained below with reference to FIG. 14.

FIG. 14 is a diagram illustrating a hardware configuration example. As illustrated in FIG. 14, a computer 100 includes an operating unit 110a, a speaker 110b, a camera 110c, a display 120, and a communication unit 130. Furthermore, the computer 100 includes a CPU 150, a ROM 160, an HDD 170, and a RAM 180. These components 110-180 are connected to one another via a bus 140.

As illustrated in FIG. 14, the determination program realizing the same functions as those of the acquiring unit 21, the evaluated value computing unit 22, the tendency estimating unit 23, the determining unit 24, the warning unit 25, and the driving scheduling unit 26 illustrated in the first embodiment is stored in the HDD 170. The determination program may be integrated or dispersed similarly to the components of the acquiring unit 21, the evaluated value computing unit 22, the tendency estimating unit 23, the determining unit 24, the warning unit 25, and the driving scheduling unit 26 illustrated in FIGS. 3, 9, etc. In other words, all data illustrated in the first and second embodiments are not necessarily stored in the HDD 170, and thus it is only sufficient that data used for the process is stored in the HDD 170.

Under the circumstances, the CPU 150 reads out the determination program from the HDD 170 and then loads it into the RAM 180. As a result, the determination program functions as a determination process as illustrated in FIG. 14. The determination process loads various data read from the HDD 170 into an area assigned to the determination process among storage areas of the RAM 180, and performs various types of processes by using the loaded various data. For example, as an example, a process that is executed by the determination process includes the process etc. explained in each embodiment. All processing units illustrated in the first embodiment are not necessarily operated by the CPU 150, and it is only sufficient that a processing unit corresponding to a process as a target for execution is realized virtually.

The determination program is not necessarily stored in the HDD 170 or the ROM 160 from the start. For example, the determination program is stored in a “transportable physical medium” such as a flexible disk, so-called FD, CD-ROM, DVD disc, magneto-optical disk, and IC card, which is inserted into the computer 100. Then, the computer 100 may acquire and perform the determination program from these transportable physical media. Moreover, the determination program is previously stored in an another computer, a server apparatus, etc. connected to the computer 100 via a public line, the Internet, LAN, WAN, etc., and the computer 100 may acquire and perform the determination program from these apparatuses.

According to one embodiment, it is possible to improve a detection accuracy of the degradation of driving ability.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a determination program that causes a computer to execute a process comprising:
acquiring at every predetermined time position information and speed information from a vehicle that travels a road;
computing, by using the position information and the speed information, a distance by which the vehicle travels from a passage of a first spot at which the road changes from a downward slope to an upward slope to a spot at which the vehicle accelerates over a first predetermined value or a distance by which the vehicle travels from a passage of a second spot at which the road changes from an upward slope to a downward slope to a spot at which the vehicle decelerates over a second predetermined value; and
determining degradation of driving ability of a driver who drives the vehicle based on the distance.

2. The non-transitory computer-readable recording medium according to claim 1, wherein
the process further includes storing, in a predetermined storage, a first probability distribution indicated by an average and a standard deviation computed by using distances computed for a plurality of vehicles that have previously traveled the first spot or a second probability distribution indicated by an average and a standard deviation computed by using distances computed for a plurality of vehicles that have previously traveled the second spot, wherein
the determining includes:
computing a probability with which the distance computed for the vehicle that has traveled the first spot is generated in the first probability distribution;
determining that the driving ability of the driver is decreasing when the computed probability is not more than a threshold;
computing a probability with which the distance computed for the vehicle that has traveled the second spot is generated in the second probability distribution; and
determining that the driving ability of the driver is decreasing when the computed probability is not more than the threshold.

3. The non-transitory computer-readable recording medium according to claim 2, wherein
the process further includes:
storing, in the predetermined storage, first probability distributions previously generated for a plurality of the first spots or second probability distributions previously generated for a plurality of the second spots; and
computing a z value of the distance in the first probability distribution corresponding to the traveled first spot for the distance computed each time the vehicle travels the first spot or a z value of the distance in the second probability distribution corresponding to the traveled second spot for the distance computed each time the vehicle travels the second spot, wherein
the determining includes determining the degradation of driving ability of the driver who drives the vehicle in accordance with the z value.

4. The non-transitory computer-readable recording medium according to claim 3, wherein
the process further includes generating a first reference distribution that is a probability distribution of the distance estimated when the vehicle travels the first spot in accordance with a plurality of the z values for a predetermined number of times computed while the vehicle is traveling the road or a second reference distribution that is a probability distribution of the distance estimated when the vehicle travels the second spot in accordance with a plurality of the z values for the predetermined number of times computed while the vehicle is traveling the road, wherein
the determining includes:
computing a probability with which the computed distance is generated the first reference distribution each time the vehicle travels the first spot;
determining that the driving ability of the driver is decreasing when subthreshold probabilities are continuously computed;
computing a probability with which the computed distance is generated in the second reference distribution each time the vehicle travels the second spot; and
determining that the driving ability of the driver is decreasing when subthreshold probabilities are continuously computed.

5. The non-transitory computer-readable recording medium according to claim 1, wherein the process further includes outputting an alert when it is continuously dete lined multiple times that the driving ability of the driver is decreasing.

6. The non-transitory computer-readable recording medium according to claim 3, wherein
the process further includes:
acquiring, each of for the plurality of vehicles that have traveled the first spot, a distance by which a corresponding vehicle travels and a driving time of the driver of the corresponding vehicle from the passage of the vehicle at the first spot to the spot at which the vehicle accelerates over the first predetermined value;
acquiring, for each of the plurality of vehicles that have traveled the second spot, a distance by which a corresponding vehicle travels and a driving time of the driver of the corresponding vehicle from the passage of the vehicle at the second spot to the spot at which the vehicle accelerates over the second predetermined value; and
specifying a relationship between the distance and the driving time from a plurality of combinations of the acquired distance and the acquired driving time and estimating a driving time at which the distance becomes not less than a threshold.

7. A determination method comprising:
acquiring at every predetermined time position information and speed information from a vehicle that travels a road, by a processor;
computing, by using the position information and the speed information, a distance by which the vehicle travels from a passage of a first spot at which the road changes from a downward slope to an upward slope to a spot at which the vehicle accelerates over a first predetermined value or a distance by which the vehicle travels from a passage of a second spot at which the road changes from an upward slope to a downward slope to a spot at which the vehicle decelerates over a second predetermined value, by the processor; and
determining degradation of driving ability of a driver who drives the vehicle based on the distance, by the processor.

8. An information processing device comprising:
a processor configured to:
acquire at every predetermined time position information and speed information from a vehicle that travels a road;
compute, by using the position information and the speed information, a distance by which the vehicle travels from a passage of a first spot at which the road changes from a downward slope to an upward slope to a spot at which the vehicle accelerates over a first predetermined value or a distance by which the vehicle travels from a passage of a second spot at which the road changes from an upward slope to a downward slope to a spot at which the vehicle decelerates over a second predetermined value; and
determine degradation of driving ability of a driver who drives the vehicle based on the distance.
